(19) United States
(12) Patent Application Publication
(10) Pub. No.: US 2014/0054209 A1
(43) Pub. Date: Feb. 27, 2014

(54) ELECTROBIOCHEMICAL REACTOR

(71) Applicant: D. Jack Adams, Park City, UT (US)

(72) Inventor: D. Jack Adams, Park City, UT (US)

(21) Appl. No.: 14/065,979

(22) Filed: Oct. 29, 2013

Related U.S. Application Data
(62) Division of application No. 13/001,962, filed on May 9, 2011.

(51) Int. Cl. C02F 3/00

(52) U.S. Cl. CPC C02F 3/005
USPC 210/150

(57) ABSTRACT

A method for removing a target compound from a liquid can include arranging two active surfaces so as to be separated by a distance. The active surfaces can be placed within a flow of the liquid and can be capable of supporting an electrical charge, biological growth, and/or enzymes and proteins. The method can further include developing a population of microorganisms concentrated on the active surfaces where the population of microorganisms is configured to or capable of transformation of the target compounds. The method can further include developing enzymes or proteins concentrated on the active surfaces where the enzymes or proteins are configured to or capable of transformation of the target compounds. The method can further include applying a potential difference between the two active surfaces. The microorganisms and the potential difference can be sufficient in combination and/or with specific nutrients to remove the target compound from the liquid and maintain the population of microorganisms. The enzymes and proteins and the potential difference can be sufficient in combination to remove the target compound from the liquid.

### RELATED APPLICATION

This application claims the benefit of copending U.S. Provisional Patent Application Ser. No. 61/076,873 filed on Jun. 30, 2008, which is hereby incorporated by reference in its entirety.

### BACKGROUND OF THE INVENTION

Metals and other inorganics like arsenic, selenium, mercury, cadmium, chromium, nitrogen, etc. are difficult to remove to levels that meet current drinking water and discharge criteria in many countries. For example, in the United States, the 2006 maximum arsenic level in drinking waters was set at 10 ppb; this may soon be the case in other countries. Maximum contaminant levels (MCL) of metals in drinking water in the United States can range 0.0005 to 10 mg/L, and can be even lower. Commonly regulated metals and inorganics include antimony, arsenic, asbestos, barium, beryllium, cadmium, chromium, copper, cyanide, fluoride, lead, mercury, nitrate, nitrite, selenium, and thallium.

There are various kinds of treatment methods for metal, inorganics, and organics removal. Technologies used to treat metal and inorganic-contaminated soil; waste and water mainly include: solidification/stabilization, vitrification, soil washing/acid extraction, reverse osmosis, ion exchange, biological treatments, physical separations, pyrometallurgical recovery, and in situ soil flushing for soil and waste contaminant treatment technologies. Precipitating/co-precipitation, membrane filtration, adsorption, ion exchange, and permeable reactive barriers are more common treatment technologies for treating contaminant water, while electrokinetics, phytoremediation, with biological treatment being a common treatment technology for removing contaminants in soils, wastewaters, and drinking waters.

### SUMMARY OF THE INVENTION

A method for removing a target compound from a liquid can include arranging two active surfaces so as to be separated by a predetermined distance. The active surfaces can be placed within a flow of the liquid and can be capable of supporting an electrical charge and biological growth. The method can further include developing a population of microorganisms concentrated on the active surfaces where the population of microorganisms is configured to or capable of acting on, transforming, or binding the target compound. The method can further include applying a potential difference between the two active surfaces. The microorganisms and the potential difference can be sufficient in combination to remove the target compound from the liquid and maintain the population of microorganisms.

Additionally, a system for removing a target compound from a liquid can include two active surfaces arranged a distance apart, and substantially parallel to each other. An electrical source can be operatively connected to each of the active surfaces in a manner so as to provide a potential difference between the two active surfaces. In another configuration, a population of microorganisms can be present on each of the two active surfaces. Additionally, the system can include a flow path sufficient to direct a majority of the liquid to contact each active surface and sufficient to direct a majority of the liquid across the distance.

The more important features of the invention have been outlined, rather broadly, so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### DESCRIPTION OF THE DRAWINGS

FIG. 1 is a dominance diagram for As₂S₃ precipitation in equilibrium with various chemical species as reported in the literature.

FIG. 2 is an Eh-pH diagram for various arsenic species.

FIG. 3 is an Eh-pH diagram for N₂—O₂—H₂O systems.

FIGS. 4A and 4B are Eh-pH diagrams for various selenium systems.

FIG. 5 is an electrobiochemical reactor having an open channel which flows parallel to and past charged electrodes in accordance with one embodiment of the present invention.

FIG. 6 is an electrobiochemical reactor having a bed of high surface area conductive material permeable to solution in a channel which flows perpendicular to and across charged electrodes in accordance with another embodiment of the present invention.

FIGS. 7A and 7B are a depiction of an electrobiochemical reactor system tested without (7A) and with applied potential (7B) and used to evaluate arsenic removal in accordance with one embodiment of the present invention.

FIGS. 8A and 8B are a depiction of an electrobiochemical reactor system tested with (8A) and without (8B) applied potential to evaluate selenium removal in accordance with one embodiment of the present invention.

FIG. 9 is a graph of measured potentials across the EBR and conventional bioreactor used to remove arsenic from test waters.

FIG. 10 is a graph of arsenic removal from several test solutions comparing the EBR with a similarly constructed reactor operated without applied voltage.

FIG. 11 is a graph of selenium removal from several mine waters using a two stage conventional bioreactor without applied potential and a retention time of 44 hrs and a single stage EBR with a retention time of 22 hr and an applied potential of 3 volts.

### DETAILED DESCRIPTION

Reference will now be made to exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

### DEFINITIONS

In describing and claiming the present invention, the following terminology will be used in accordance with the definitions set forth below.

It must be noted that, as used in this specification and the appended claims, the singular forms “a,” “an,” and “the” include plural referents unless the context clearly dictates otherwise. Thus, for example, reference to “an active surface” includes one or more of such active surfaces and reference to “a developing step” includes reference to one or more of such steps.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context. Similarly, “substantially free of” or the like refers to the lack of an identified material, characteristic, element, or agent in a composition. Particularly, elements that are identified as being “substantially free of” are either completely absent from the composition, or are included only in amounts that are small enough so as to have no measurable effect on the composition.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, thicknesses, parameters, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

### Embodiments of the Invention

An improved method for removing a target compound from a liquid can include arranging two active surfaces so as to be separated by a distance. The active surfaces can be placed within a flow of the liquid and can be capable of supporting an electrical charge and biological growth. The method can further include developing a population of microorganisms concentrated on the active surfaces where the population of microorganisms is configured to or capable of acting on or transforming the target compound. The method can further include applying a potential difference between the two active surfaces. The microorganisms and the potential difference can be sufficient in combination to remove the target compound from the liquid and maintain the population of microorganisms.

In one aspect, the target compound or compounds are recovered from the liquid. The method can be utilized to remove one or a plurality of target compounds. The active surfaces can be the same or different and can comprise a homogeneous material or a heterogeneous material. In one embodiment, the two active surfaces comprise or consist essentially of various forms of activated carbon. The step of developing a population of microorganisms can occur before or after the step of applying a potential difference. The potential difference can be adjusted to optimize results, although the potential is relatively low. As a general guideline, the voltage can be from about 1 to about 110 V, and often from about 1 to about 10 V.

The amount of voltage that can be applied is generally application dependent, but should range between the minimal amount that effectuates an improvement in the removal or recovery of the target compound, and an upper range that is less than an amount that damages or reduces the microorganism population. While there are water treatment applications wherein voltage is utilized to reduce or eliminate microorganisms, the present application of voltage is to enhance the activity of the microorganism population in removing target compounds, and as such, a voltage sufficient to cause damage to the microorganism population inherently lessens the efficacy of the system. Variations in size of reactor, particular microorganisms utilized, and other parameters of reactor design can affect the amount of voltage that is optimal.

The charged surfaces described herein can have a high surface area and can include or consist essentially of activated carbon, metal and/or functional group impregnated activated carbon, metals such as platinum, graphite and many other metal alloys, conductive gels and plastics in multiple configurations. Electrode configurations can include electrode rods, plates, fabrics, pellets, granules, etc. present in high surface area configurations. These materials can also contain immobilized, incorporated, or bound bacteria and/or specific microbes or microbial materials, such as proteins and enzymes known for their ability to bind, transform, or degrade various metals, inorganics, or organics.

The applied voltage supplies a continuous supply of electrons and an electron sink that enables the microbial biofilms or enzyme impregnated surfaces to remove or transform contaminants more effectively.

Additionally, a system for removing a target compound from a liquid can include two active surfaces arranged a distance apart, and substantially parallel to each other. An electrical source can be operatively connected to each of the active surfaces in a manner so as to provide a potential difference between the two active surfaces. A population of microorganisms can be on each of the two active surfaces. Additionally, the system can include a flow path sufficient to direct a majority of the liquid to contact each active surface and sufficient to direct a majority of the liquid across the distance. In one aspect, the system can be arranged in-situ. In a further aspect, the in-situ arrangement can include a stream or other flowing body of water, wherein the natural stream of flowing body provides the flow path. In another example, the system can be part of a permeable reactive barrier which treats underground wastewater along a plume, portions of a water table, or the like.

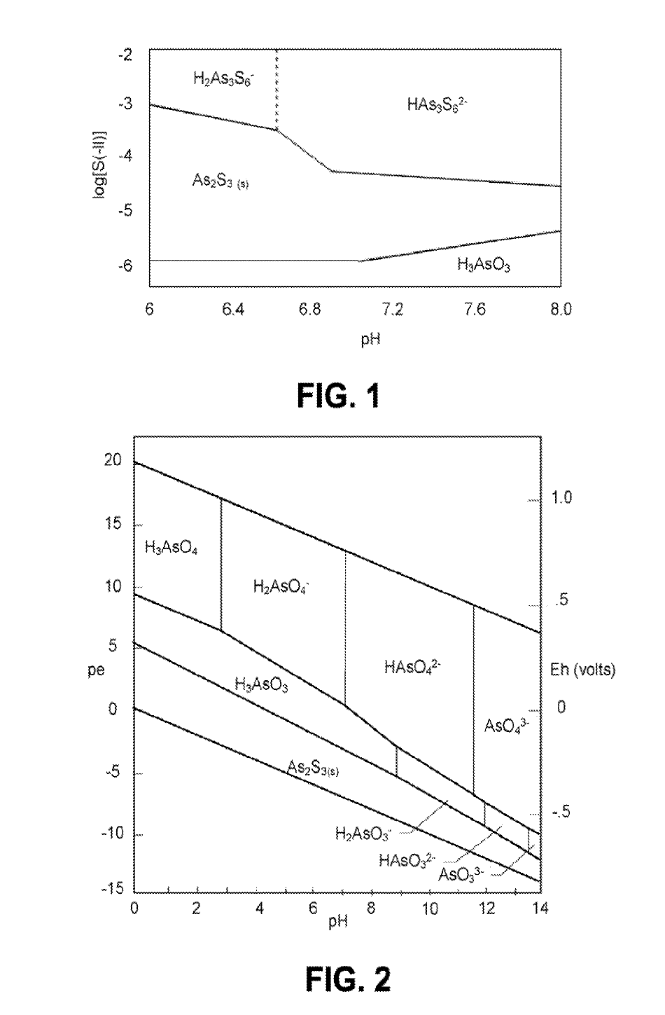

The microorganisms can act to remediate a target compound. Inorganic solution components, nutrients, including carbon or energy sources (e.g. molasses, yeast extract, proteins, and the like), may at times be a limited material for microbial cell synthesis and growth. The principal inorganic nutrients needed by microorganisms are N, S, P, K, Mg, Ca, Mg, K, Fe, Na, and Cl. In one embodiment, microbes can convert nitrates or nitrites to nitrogen gas using them as terminal electron acceptors. Excess nitrate or nitrite present receives electrons from the system. In another embodiment, selenates and selenites are reduced to elemental selenium. In still another embodiment, As(V) can reduce to As(III) and, in the presence of sulfides, As(III) can precipitate as As₂S₃, as shown in FIG. 1. As such, the present invention provides electrobiochemical reactors that can create enough reductive conditions such that these inorganics are converted to insoluble forms or degraded to carbon dioxide and other gases, e.g. nitrogen.

Generally, redox processes can be mediated by microorganisms, which serve as catalysts in speeding up the reactions. These microorganisms, including many bacteria, can use redox reactions in their respiratory processes. In oxygen-rich environments, oxygen can be the natural electron acceptor, but other electron acceptors can also be used and will generally follow a distinct order when the previous electron acceptor has been consumed or nearly consumed based on their redox potential. As a guideline, the order is based on the amount of energy available to the system from the electron acceptor. For example, oxygen provides the highest amount of energy to the system; nitrate provides a slightly smaller amount. This is shown in Table 2.

The term redox represents a large number of chemical reactions involving electron transfer. When a substance is oxidized, it transfers electrons to another substance, which is then reduced. The point at which a given reaction can take place is determined by the electrical potential difference or redox potential (Eh) in the water; some reactions liberate energy, other require energy input. Redox potential and pH can be important factors controlling inorganic speciation and mobilization. An Eh-pH diagram for arsenic is shown in FIG. 2. The diagram represents equilibrium conditions of arsenic under various redox potentials and pH. Arsenate [As(V)] is dominant in oxygenated water, which tends to induce high Eh values, whereas arsenite [As(III)] is dominant in non-oxygenated water. The conversion of As(V) to As(III) may take a long time due to biogeochemical processes in the environment. This may be one of the reasons why As (V) can be found in some anoxic waters.

The sequence begins with the consumption of O₂ and thereafter NO₃ is used. Manganic oxides dissolve by reduction of Mn² and thereafter NH₄ is produced through ammonification. Thus, in the absence of oxygen nitrates readily degenerate to nitrogen gas when used as electron acceptors.

These processes can be followed by the reduction of hydrous ferric oxides to Fe² Finally, SO₄²⁻ can be reduced to H₂S and CH₄ is produced from fermentation and methanogenesis. As(V) reduction is normally expected to occur after Fe(III)-oxide reduction, but before SO₄²⁻ reduction. The thermodynamic information describes only the system at equilibrium and generally indicates the direction in which a non-equilibrium system will move.

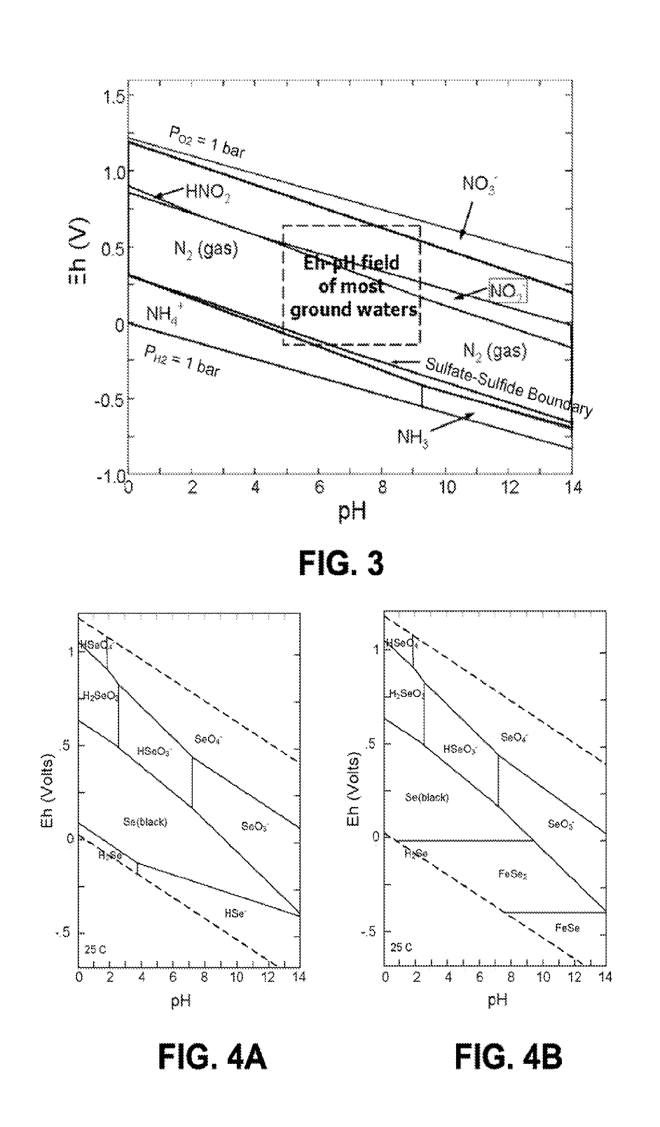

FIG. 3 provides an Eh-pH stability diagram for nitrate. Generally, nitrate (NO₃⁻) can be present in significant quantities in waters containing free oxygen. Additionally, ammonium ion and ammonia can be present in very reducing waters. The nitrogen cycle can be quite complicated, and although not shown by the equilibrium Eh-pH diagram, transformation among the various oxidation states can occur almost entirely under the influence of microbes. FIG. 4 provides a Eh-pH diagram for selenium and selenium-iron, respectively. As shown from FIGS. 3 and 4, the present electrobiochemical reactors can advantageously use redox potentials to remediate target compounds through reactions with microorganisms, as previously discussed.

Reduction of other species can be accomplished using similar reduction mechanisms. Table 1 illustrates a sample of some exemplary reduction mechanisms which can occur under conditions of the present invention.

TABLE 1

| Reaction | Eₕ (V) | ΔG |
|---|---|---|
| Reduction of O₂ | | |
| O₂ + 4H⁺ + 4e⁻ --> 2H₂O | +0.812 | −29.9 |
| Reduction of NO₃⁻ | | |
| 2NO₃⁻ + 6H⁺ + 6e⁻ --> N₂ + 3H₂O | +0.747 | −28.4 |
| Reduction of Mn⁴⁺ | | |
| MnO₂ + 4H⁺ + 2e⁻ --> Mn²⁺ + 2H₂O | +0.526 | −23.3 |
| Reduction of Fe³⁺ | | |
| Fe(OH)₃ + 3H⁺ + e⁻ --> Fe²⁺ + 3H₂O | −0.047 | −10.1 |
| Reduction of SO₄²⁻ | | |
| SO₄²⁻ + 10H⁺ + 8e⁻ --> H₂S + 4H₂O | −0.221 | −5.9 |
| Reduction of CO₂ | | |
| CO₂ + 8H⁺ + 8e⁻ --> CH₄ + 2H₂O | −0.244 | −5.6 |

Although not intended to be limiting, these mechanisms include respiration, denitrification, manganese reduction, ammonification, iron reduction, sulphate reduction, and methanogenesis, respectively.

The present invention can be geared towards a specific target chemical in a fluid, and can provide specific design considerations for removing the target chemical, as well as the specific equipment that can be used. However, it should be understood that, while the embodiments discussed in the disclosure can be specific, the applicability of the method and equipment can be used for numerous target compounds. Indeed, the present method and equipment described herein can equally be applied to the targeting and removal of various target compound(s) from a fluid, wherein microorganisms and a potential difference together affect the compounds chemical make-up, solubility, dispersibility, binding, and/or transformation, or otherwise enhance removal or recovery of the target compound or compounds. For example, in one embodiment, the present electrobiochemical reactors can treat mine wastewater containing nitrate-N and arsenic.

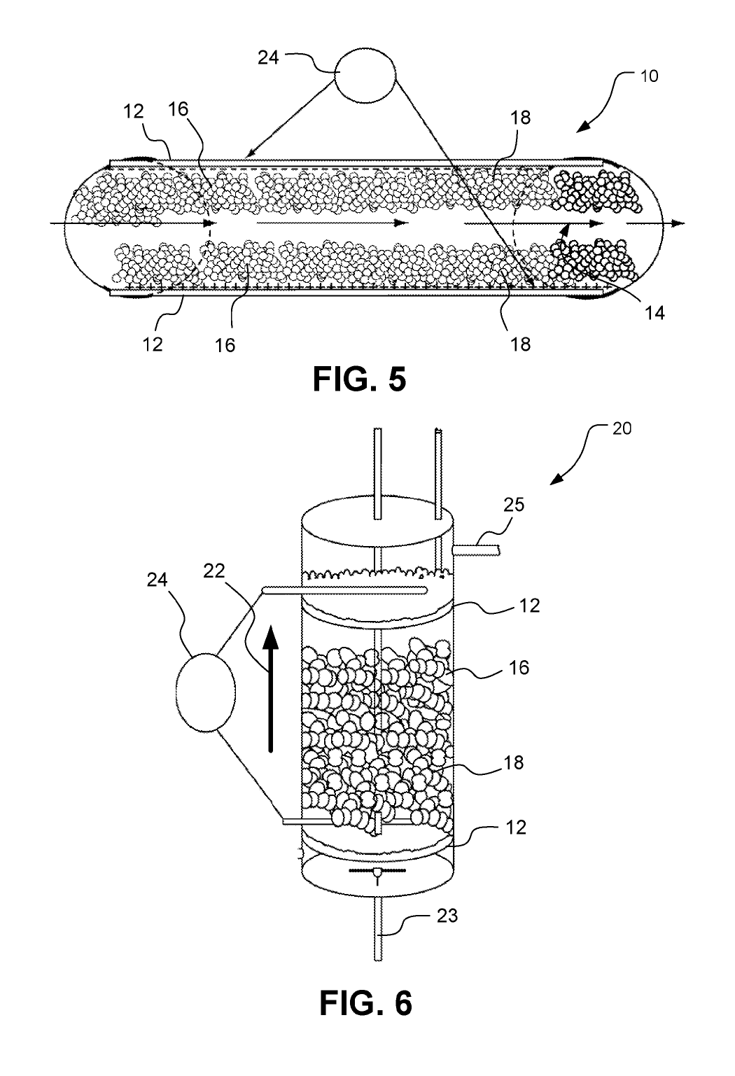

As previously noted, a system for removing a target compound from a liquid can include two active surfaces arranged a distance apart, and substantially parallel to each other. Two non-limiting configurations of electrobiochemical reactors of the present invention are shown in FIGS. 5 and 6. FIG. 5 shows a plug flow reactor 10 having parallel electrodes plates 12 oriented parallel to the direction of fluid flow 14. These electrodes include an electrically conductive high surface area material 16, which supports growth of desired microorganisms 18. FIG. 6 illustrates another plug flow configuration 20 where the electrodes 12 are oriented perpendicular to the direction of fluid flow 22. A feed solution inlet 23 can introduce the fluid into the reactor 20 and the treated fluid having a reduced concentration of target compound can be removed via effluent line 25. In this case, the fluid to be treated flows across the electrodes in contrast to the embodiment of FIG. 5 where the fluid flows past or along the electrodes.

The active surfaces can be any material having a high surface area that can support an electrical charge (conductive), and can further support microorganism growth. Furthermore, in one embodiment, the active surface can be moderately resistant to plugging, overgrowth, and/or decay. As a very general guideline, suitable active surface materials can include, but are in no way limited to, plastics, zeolites, silicates, activated carbons, starches, lignins, celluloses, plant materials, animal materials, biomaterials, and combinations thereof. In another specific embodiment of the present invention, the substrate can be a mesoporous material. Activated carbon surfaces and/or platinum-containing materials, including activated carbons, can be effective materials for use as the primary conductive surfaces. These primary surfaces can be in contact with other more economical conductive high surface area materials, e.g., secondary conductive high surface area materials, providing an extended large surface area for contaminant transformation and/or binding. For example, plastics, biopolymers, pumice, aluminum or iron impregnated materials can be used as primary and/or secondary substrate material. Biological support materials can have functional groups, which are selected and optimized for a particular target material to be removed. For example, and in order of increasing basicity, inactive hydrogen, carboxyl, lactone, phenol, carbonyl, ether, pyrone, and chromene groups are non-limiting examples of suitable functional groups for a biological support material in accordance with the present invention.

An electrical source 24 can be operatively connected to each of the active surfaces in a manner so as to provide a potential difference between the two active surfaces as shown in FIGS. 5 and 6. A population of microorganisms can be on each of the two active surfaces and more economical high surface-area conductive materials. Additionally, the system can include a flow path sufficient to direct a majority of the liquid to contact with each primary active surface and sufficient to direct a majority of the liquid across the distance.

The electrobiochemical reactor (EBR) can be formed using cylindrical vessels as part of the flow path, oriented so as to have a diameter substantially vertical as shown in FIGS. 6-8. A perforated plate can be used to suspend carbon at the bottom and another at the top, thus forming active high surface areas. The plate can act as a substrate for the active surfaces. Therefore, the plate can be formed of any suitable material which may be conductive (e.g. metal) or non-conductive (e.g. plastic). In some cases, non-conductive plates can be useful in order to avoid disintegration due to electrochemical erosion.

The reactor can be inoculated, wherein a population of microorganisms is developed on the active surfaces, in a variety of ways and at different times. At times, it may be necessary or useful to deliberately inoculate the active surfaces. At other times, the fluid, such as water to be treated, may have a minor microorganism population associated with the fluid that may, with adequate time and conditions, naturally inoculate the active surfaces.

A number and variety of microorganisms can be utilized to inoculate the active surfaces, either alone, or in combination. Non-limiting examples of bacteria and algae that may be utilized include Cyanobacteria, Diatoms, Alcaligenes sp., Escherichia sp., Pseudomonas sp., Desulfovibrio sp., Shewanella sp., Bacillus sp., Thauera sp., P. putida, P. stutzeri, P. alcaligenes, P. pseudoalcaligenes, P. diminuta, Xanthomonas sp. including X. (Pseudomonas) maltophilia, Alc. Denitrificans, various Bacillus species Bacillus species that are versatile chemoheterotrophs including B. subtilis, B. megaterium, B. acidocaldarius, & B. cereus, Cellulomonas and Cellulomonas Fermentans, various sulfate reducing bacteria including Desulfobacter, Desulfobulbus, Desulfomonas, Desulfosarcina, Desulfotomaculum, Desulfurocococcus, Desulfotomaculum, and Desulfuromonas species, Nitrosomonas, Nitrobacter, Rhodobacter, Thiobasillus, and Geobacter species, E. coli, and various Achaea bacteria and combinations thereof. The premix consortium of identified microbes were grown to high concentration and added to the electrobiochemical reactors.

Although up-flow type reactors are shown in FIGS. 6-8, it should be noted that a variety of designs could be utilized, including a down-flow, horizontal flow, flow along any pathway, plug flow, semi-continuous, batch, fluidized bed, etc. Furthermore, wherein a flow path is pre-existing, active surfaces could be inserted a distance apart to form a system for removing a contaminant or target compound. Such is the case with an in-situ formation of an electrobiochemical reactor in a runoff stream.

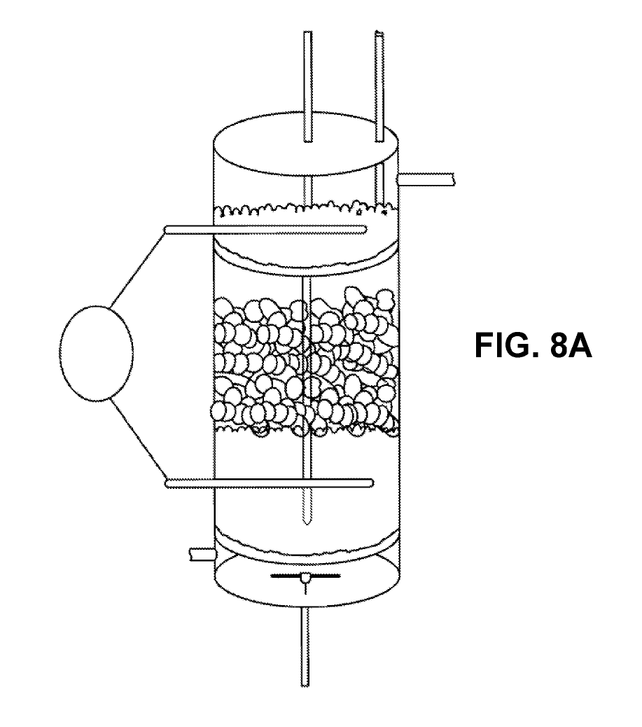

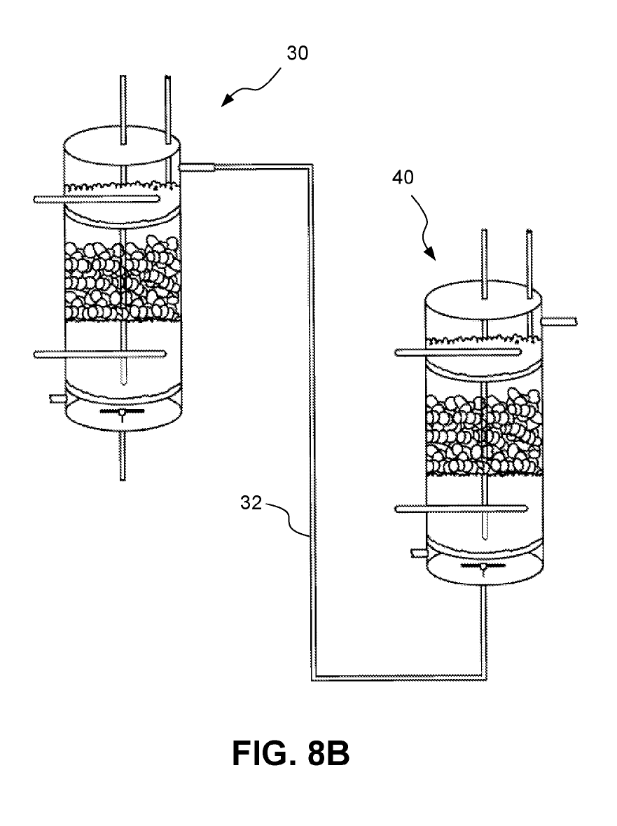

Turning now to FIG. 8b, a system for removing at least one target compound from a liquid can comprise a) a first electrobiochemical reactor 30, comprising i) two active surfaces arranged a distance apart and arranged substantially parallel to each other, ii) an electrical source operatively connected to each of the active surfaces to provide a potential difference between the two active surfaces, and iii) a population of microorganisms on each of the two active surfaces. The system can further comprise a second electrobiochemical reactor 40, comprising i) two active surfaces arranged a distance apart and arranged substantially parallel to each other, ii) an electrical source operatively connected to each of the active surfaces to provide a potential difference between the two active surfaces, and iii) a population of microorganisms on each of the two active surfaces. Additionally, the system can comprise a tube 32 that connects the first electrobiochemical reactor to the second electrobiochemical reactor such that the liquid exiting the first electrobiochemical reactor enters the second electrobiochemical reactor. As discussed above, the system can also include a flow path sufficient to direct a majority of the liquid to contact each active surfaces of each electrobiochemical reactor and sufficient to direct the majority of the liquid across the distances of each electrobiochemical reactor.

Additionally, the electrobiochemical reactors may include any of the aforementioned embodiments discussed throughout the present disclosure. For example, the present system can include the microorganisms previously discussed. Further, the electrobiochemical reactors can be the same or different; e.g., have the same or different components or target the same or different target compounds.

### EXAMPLES

The following examples illustrate various embodiments of the invention. Thus, these examples should not be considered as limitations of the present invention, but are merely in place to teach how to implement the present invention based upon current experimental data. As such, a representative number of systems are disclosed herein.

### Example 1

### Removal of Contaminants from Mining Waste Water

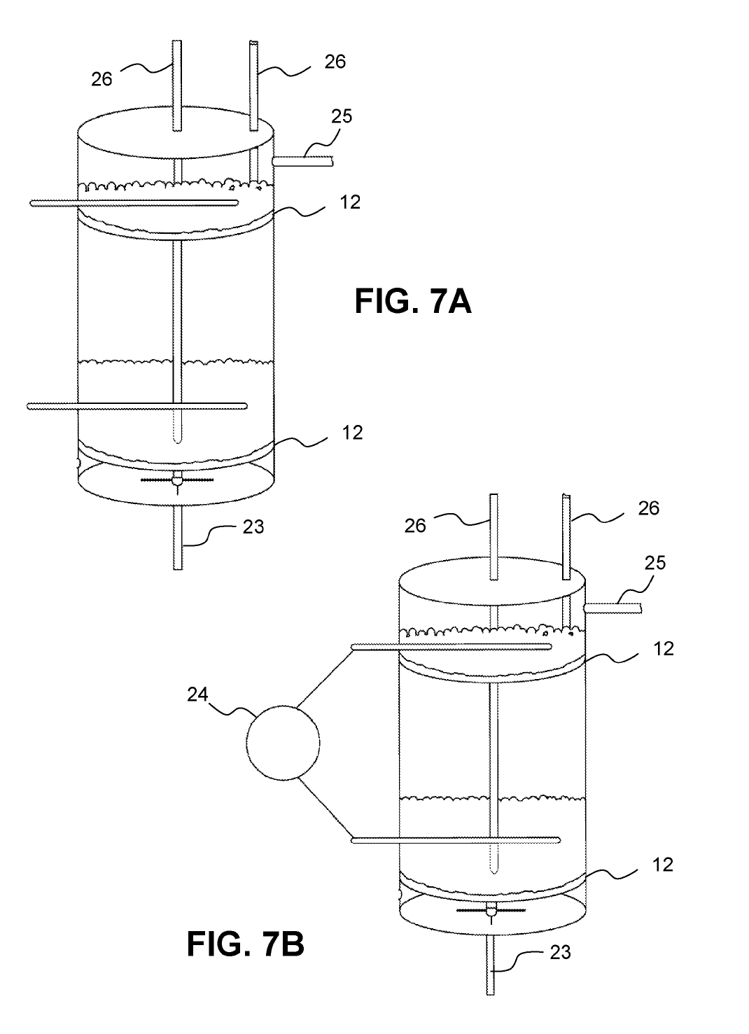

The present example targeted the removal of arsenic, selenium, and nitrate from various mining waters, and further tested a combination of microbes exposed to various potential differences. Two identical reactors with the same features, were tested side by side, shown in FIGS. 7A and 7B. One of the reactors, 7A, did not have an applied potential across its electrodes 12 (Reactor R1) and the other, 7B, did have applied potential 24 across the electrodes 12 (Reactor R2). The reactors were fabricated from transparent plastic. The EBR's tested were of several different sizes and configurations. In one configuration, both the cathode and anode carbon beds sat on perforated diaphragms. The carbon used was of size 20×20 mesh or pelletized activated carbon. The cathode and anode carbon beds were of different sizes to determine the effectiveness of different configurations. Embedded in each carbon bed was a firmly-held electrode system sealed to the outside with silicon gel. The electrodes helped maintain the reduction potential gradient through the electrobiochemical reactor. Various tubes, running from the top plate and ending at different locations within the EBR's tested served the purpose of sampling and monitoring the transformation of the contaminants arsenic, selenium, and nitrate-N. The bench-top EBR's tests were conducted at an ambient temperature of ˜25° C.

The electrobiochemical reactor setup used for arsenic removal is shown generally in FIGS. 7A and 7B and includes two electrobiochemical reactors, respectively: one without an applied potential (FIG. 7A) and a second with applied potential (FIG. 7B); two sampling ports on each reactor 26; power source 24; pump mechanism (not shown) and connecting tubes (not shown); and a solution feed container (not shown). FIG. 8A similarly shows a single stage electrobiochemical reactor of the present invention and FIG. 8B shows a two-stage biochemical reactor without applied potential used to test selenium removal as further discussed in Example 2. In this manner, the present invention can be compared in performance with and without applied voltage.

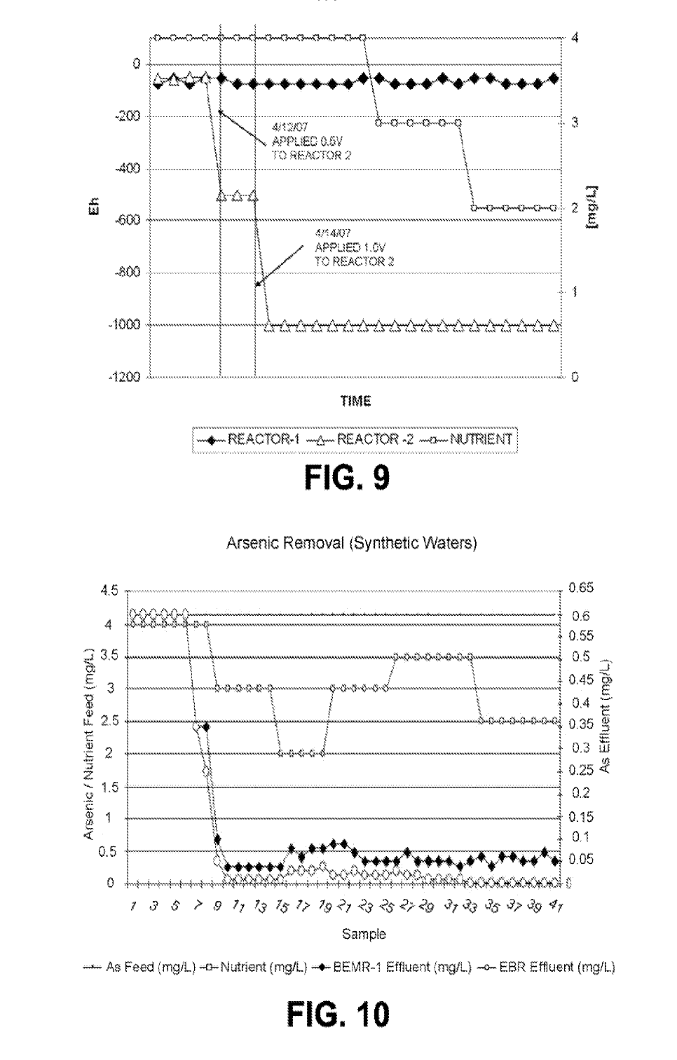

Although a variety of microbes could be used, the microbes used were a consortium of Pseudomonas and sulfate-reducing microbes that could effectively carry out arsenic reduction from As (V) to As (III), selenium reduction from selenate and selenite to elemental selenium (for Example 2) as well as denitrification. The same microbes were introduced into both the standard bioreactors without applied potential and the electrobiochemical reactors. FIG. 9 shown differences in measured potentials across Reactor R1 and Reactor R2.

Performance variations between the EBR with applied potential (Reactor R2) and the EBR without applied potential (Reactor R1) can be explained by noting that in the case of the reactor with the applied potential (FIGS. 7B, 8A), the cathode provides additional electrons for the reduction of the nitrogen compounds (nitrates and nitrites) to nitrogen gas, as well as the reduction of sulfate to sulfide, the reduction of arsenate to arsenite, and selenium to elemental selenium which otherwise would have to be provided by means of bacterial action and additional nutrients. Nutrients are being used to establish a reducing environment and microbial growth in the reactor without the applied potential (FIG. 7A). The EBR with applied potential showed a greater efficiency in performance as compared to the EBR without applied potential.

With the applied potential to the EBR with the iron electrodes, corroding of the iron electrode was expected to increase thereby increasing the ferrihydrite suspension in the reactor 2. This enabled additional co-removal of As (V) with iron precipitation. Iron can also be included in the feed solution to enhance the iron co-precipitation of arsenic. The increase in the iron oxide surface with this suspension aided the reduction of As (V) to As (III) at the top section of the reactor.

In testing for arsenic removal at a flow rate of 5.045 liters/day, the EBR was able to remove all nitrogen present from the feed solution. The arsenic concentration of 200 ppb in the feed was also reduced to 35 ppb as opposed to a conventional bioreactor that only reduced the feed arsenic concentration from 200 ppb to 75 ppb. FIG. 10 shows arsenic removal in an extended run of a paired bioreactor system; a conventional bioreactor and an EBR with the EBR running at different voltages. Three volts in this system produced the best results. Three volts reduced the time required for arsenic reduction and the amount of nutrients utilized in the bioreactor system. The improved performance of the EBR is due to the applied potential which sustained a reduction potential in the reactor. Therefore, an EBR process, utilizing two active surfaces arranged a distance apart and having a potential difference between them, as well as microorganism growth on each active surface, showed a distinct advantage in efficiency of removing arsenic from solution.

Thus, the present results show that the EBR was effective in removal of contaminants. Further, the present results show that the EBR can be effective even when decreasing the nutrient requirement; thereby providing lower operational cost. It was also demonstrated; when mine water was passed through the reactors, that the designed system could be used to treat a wide variety of wastewater bodies with different contaminant metals.

In light of the above, a set of such electrobiochemical reactors having the potential difference, optionally in series with a filtration system that would remove debris, and coupled with ultra-violet purification unit, can serve industries and process plants that intend to recycle their water by treating their plant effluents. The benefits to be derived are numerous, and include: lower cost of infrastructure implementation and operation compared to other treatment methods; use of simple reactors to produce hundreds to thousands times less sludge than conventional metal precipitation processes, that permit for the decontamination or reclamation of a number of target chemicals wherein the electro-mechanical biochemical reactor can be applied to a number of liquids as well as a number of target compounds.

### Example 2

### Selenium Removal from Mining Water Waste

In another exemplary embodiment, the electrobiochemical reactor, and similar methods as presented here, was utilized to remove selenium from water. Mining water was obtained from an undisclosed potential mining site.

Three 1.4-liter (approximately) reactors were used for reactor testing. All the materials used in the reactor were acrylic or polyvinyl chloride. Two fixed bed reactors packed with pumice and activated carbon were run in series as shown in FIG. 8b. A third reactor an EBR packed with pumice and activated carbon with applied voltage using a DC power supply was used separately for testing selenium reduction in mine water. All three reactors have similar sampling ports in the head for measuring pH, oxidation-reduction potential (ORP) and temperature at different depths. The reactors were maintained under anaerobic conditions.

Lab scale electrobiochemical reactors were constructed to investigate the applicability of a selected microbial consortium to remove high concentrations of soluble selenium, as selenate and selenite and to improve retention times in the electrobiochemical reactors. Three reactors each having a volume of 0.001387 m³ were used for testing. Acrylic columns used for the reactors had a height of 9.5 inches and radius of 1.5 inches. The reactors were sealed with polyvinyl chloride caps on the top and bottom having a radius of 1.5 inches and height 2.5 inches.

Two reactors packed with pumice material (volcanic rock) and activated carbon were connected in series and further connected to a pump and feed water. Feed water was actual mine water containing mainly selenium as selenate. The feed water entered the first reactor (Reactor 1) from the bottom, passed through the packed bed supporting microbes in the upward direction, exited out from the top and then entered from the bottom of the second reactor (Reactor 2). Effluent was collected from the top portion of the second reactor. Retention times of 22 and 44 hours were tested for the reactors connected in series. Anaerobic conditions were maintained in all the reactors. An electrobiochemical reactor (Reactor 3) was an electrochemical reactor packed with pumice and activated carbon and has voltage applied across the reactor through a set of electrodes imbedded in activated carbon layers at the top and bottom of the reactor. Pelletized activated carbon material was used as the electrode in the system. The reaction was carried out with a mixture of selenate containing substrate and consortium of microbes having the capability to catalyze the reduction process and mine water was used for testing.

The feed water was pumped to the third reactor. All the reactors were provided with 3 sampling ports for measurement of pH, oxidation-reduction potential (ORP) at different locations in the reactors. Samples for selenium analysis were collected after the water comes out from the Reactor 1 (Reactor 1 effluent) and effluent coming out from the Reactor 2. Sampling for pH, ORP and temperature were performed once in three days. The third EBR reactor was tested separately for selenium removal.

Microbial consortia were tested to determine the effects of different nutrients on growth and selenium reduction. As was discussed under the testing for arsenic removal (Example 1), many different carbon amendments were used to stimulate selenate conversion to elemental selenium in water. Bacteria require three major nutrient components: carbon, nitrogen and phosphorous for growth and other activities. Stoichiometric amounts of carbon can be calculated for various inorganic removals. While these equations give the amount of carbon needed for metal reduction, additional amounts of carbon are required for the growth of the microbe and to create a reducing environment. Hence different amendments were tested in this research to see the effectiveness of different nutrients in combination with an applied voltage to stimulate the reduction of selenate and selenite to elemental selenium and enhance the growth of the microbes.

The design of this testing of an electrobiochemical reactor has the following fundamental functions: (1) immobilize the micro-organisms on an inert media, with an optimal retention time of the mine water for the organisms to act on the selenium and (2) construct a series of electrobiochemical reactors connected in tandem by using pumice (volcanic material) or other high surface area materials as the material for the active surfaces (3) the natural porosity of pumice forms a niche for and supports dense bacterial growth (4) in addition, the pores might help in material transfer (5) another possible utility with pumice is that it could occlude reduced selenium in the reactor.

The mine water tested naturally contained selenium as selenate and was used as the feed water and TSB was used as nutrient. Selenium analysis was conducted on a daily basis. Different mine waters were used over the course of the experiment which had pH varying from 10.2 to 10.3. The pH in the mine water was adjusted to a concentration ranging between 6.8 to 7.2 before pumping it through the reactors. This was performed to avoid toxicity of high pH concentration on the activity of the microbes. The pH and Oxidation-Reduction potential (ORP) were measured on a daily basis at different depths in the reactors and room temperature was recorded frequently.

The pH of the water was monitored on a daily basis to ensure that it is in the range of normal physiological conditions of the microbes and is not toxic or does not inhibit the activity of microbes. The pH measurements observed for different samples fluctuated between pH 6.6 and 7.4 with some periodicity in both the reactors. This fluctuation can be attributed to dilution effects of the feed and media addition. Over the course of the electrobiochemical reactors testing, there was a continuous decrease in the oxidation-reduction potential from day 0 to day 83.

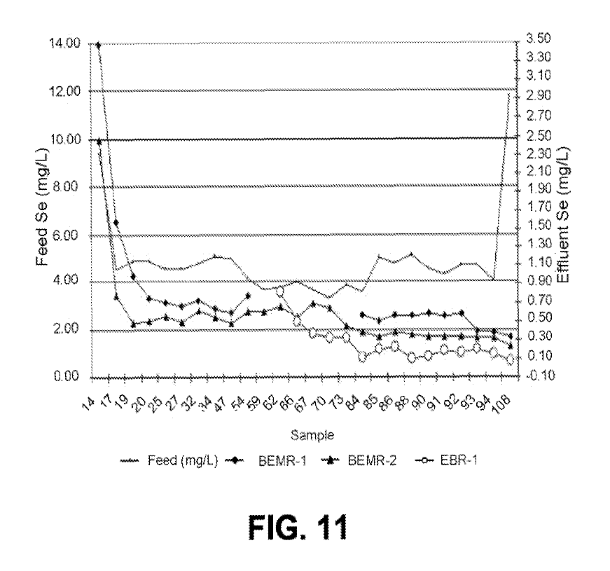

FIG. 11 provides a graph of selenium removal from several mine waters using a two stage conventional bioreactor without applied potential and a retention time of 44 hrs and a single stage EBR with a retention time of 22 hr and an applied potential of 3 volts and Tables 2 and 3 shows a list of metals added and removed from solution in a conventional bioreactor and an EBR using a composite metal electrode and mining wastewaters containing selenium.

TABLE 2

| Item (μg/L) | Al | S | Fe | Ni | Cu | Zn |
|---|---|---|---|---|---|---|
| Feed Waters | 998.95 | 460.67 | 32.0 | 6.23 | 3.00 | 19.48 |
| BEMR-1 Effluent | 162.63 | 421.73 | 177.37 | 8.31 | 3.00 | 21.77 |
| (series with 22 | | | | | | |
| hour retention) | | | | | | |
| BEMR-2 Effluent | 58.17 | 339.88 | 255.68 | 11.49 | 4.05 | 32.51 |
| (series with 44 | | | | | | |
| hour retention) | | | | | | |
| EBR Effluent (22 | 23.21 | 176.09 | 339.41 | 10.41 | 3.04 | 31.65 |
| hour retention) | | | | | | |
| Eluted from Pumice | 200.07 | 0.00 | 175.19 | 1.22 | 1.07 | 7.73 |
| (gm) | | | | | | |

TABLE 3

| Item (μg/L) | As | Mo | Ag | Cd | Sb | Pb | Hg |
|---|---|---|---|---|---|---|---|
| Feed Waters | 2.61 | 632.52 | 2.04 | 1.77 | 14.93 | 5.02 | 2.15 |
| BEMR-1 Effluent | 2.67 | 57.64 | 0.30 | 0.16 | 6.21 | 0.77 | 3.41 |
| (series with 22 | | | | | | | |
| hour retention) | | | | | | | |
| BEMR-2 Effluent | 1.93 | 12.25 | 0.21 | 0.06 | 3.05 | 2.61 | 1.46 |
| (series with 44 | | | | | | | |
| hour retention) | | | | | | | |
| EBR Effluent (22 | 1.40 | 55.65 | 0.00 | 0.18 | 10.69 | 5.31 | 2.74 |
| hour retention) | | | | | | | |
| Eluted from Pumice | 0.00 | 0.00 | 0.00 | 0.00 | 0.00 | 0.00 | 0.08 |
| (gm) | | | | | | | |

The ORP curves showed a drastic change in the values during initial 40 days in both reactors. Reactor 1 shows negative oxidation reduction potential after 35 days and Reactor 2 exhibited negative value after 40 days of operation. Similar trends observed for samples collected from different locations of reactor indicate characteristics of water being similar throughout the reactor. Decrease in ORP, initially due to provided nutrients, could be indicative of metal ion accumulation—i.e., selenium. Selenate species should exist at higher ORPs when compared to elemental selenium. Possible explanation for this is oxygen consumption from the surrounding environment by the bacteria and nutrient added creating a strong reducing environment.

Transformation of selenate to elemental selenium was also observed to be higher over the period of negative ORP. The two reactors were fed in series by adding TSB to the feed water on a daily basis at a concentration of 3.75 g/L of mine water for a period of 56 days. A retention time of 12 hours corresponding to a flow rate of 0.96 ml/min was maintained in each reactor for a period of 18 days. When retention time was 12 hours, on an average 73% reduction in selenate for both the reactors was observed. However, increasing the retention time to 22 hours in each reactor increased the selenium reduction to 83% average reduction in the Reactor 1 effluent. Calculations for the performance of the reactors were made by excluding the extreme low and high points. Addition of TSB to the feed water resulted selenium reduction in the feed water itself The feed water had a significant drop in selenate concentration on the 41^{st} day. Bioreactors reactors 1 and 2 in series on an average showed a reduction of 88.2% with a total retention time of 44 hours. The Electrobiochemical reactor showed an average reduction of 91.5% with a retention time of 22 hours, FIG. 11.

Therefore, the two conventional bioreactors in series having a retention time of 44 hours showed an average reduction of 88.2%, and the Electrobiochemical reactor 3, having the applied potential with external electrodes, which is a single unit operation, showed an average reduction of 91.5% in 22 hours. Electrobiochemical reactor 3 was far more efficient in reducing selenium with only half the retention time of electrobiochemical reactors 1 and 2, FIG. 11.

Once metal and target contaminants are immobilized using the biochemical reactors of the present invention, these can be isolated and treated, disposed of, or recovered using any number of techniques.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function, and manner of operation, assembly, and use may be made without departing from the principles and concepts set forth herein.

1.-13. (canceled)

14. A system for removing a target compound from a liquid, comprising:
two active surfaces arranged a distance apart and arranged substantially parallel to each other; an electrical source operatively connected to each of the active surfaces to provide a potential difference between the two active surfaces; a population of microorganisms on each of the two active surfaces; and a flow path sufficient to direct a majority of the liquid to contact each active surfaces and sufficient to direct the majority of the liquid across the distance.

15. The system of claim 14, wherein the system is arranged in-situ.

16. The system of claim 14, wherein the flow path flows parallel to and past the two active surfaces.

17. The system of claim 14, wherein the flow path flows perpendicular to and across the two active surfaces.

18. The system for removing at least one target compound from a liquid, comprising a) a first electrobiochemical reactor, comprising i) two active surfaces arranged a distance apart and arranged substantially parallel to each other, ii) an electrical source operatively connected to each of the active surfaces to provide a potential difference between the two active surfaces, and iii) a population of microorganisms on each of the two active surfaces; b) a second electrobiochemical reactor, comprising i) two active surfaces arranged a distance apart and arranged substantially parallel to each other, ii) an electrical source operatively connected to each of the active surfaces to provide a potential difference between the two active surfaces, and iii) a population of microorganisms on each of the two active surfaces; c) a tube that connects the first electrobiochemical reactor to the second electrobiochemical reactor such that the liquid exiting the first electrobiochemical reactor enters the second electrobiochemical reactor; d) a flow path sufficient to direct a majority of the liquid to contact each active surfaces of each electrobiochemical reactor and sufficient to direct the majority of the liquid across the distances of each electrobiochemical reactor.

19. The system of claim 18, wherein the system removes at least two target compounds.

20. The system of claim 19, wherein the first electrobiochemical reactor removes a first target compound and the second electrobiochemical reactor removes a second target compound.

21. The system of claim 19, wherein the microorganisms of the first electrobiochemical reactor are different than the microorganisms of the second electrobiochemical reactor.

22. The system of claim 19, wherein the flow path flows perpendicular to and across the two active surfaces of each of the electrobiochemical reactors.

23. The system of claim 1, wherein the system is arranged in-situ.

24. The system of claim 1, wherein the first electrobiochemical reactor removes a first target compound and the second electrobiochemical reactor removes a second target compound.

25. The system of claim 1, wherein the microorganisms of the first electrobiochemical reactor are different than the microorganisms of the second electrobiochemical reactor.
